(19) United States
(12) Patent Application Publication
(10) Pub. No.: US 2026/0169732 A1
(43) Pub. Date: Jun. 18, 2026

(54) SYSTEM AND METHOD FOR SCHEMA REGISTRY FOR MESSAGING

(71) Applicant: JPMorgan Chase Bank, N.A., New York, NY (US)

(72) Inventors: Shailesh SINGH, Frisco, TX (US); James WEI, Naperville, IL (US); Truong VO, Fort Worth, TX (US); Anthony NGUYEN, Plano, TX (US); Seshagiri Rao VASANTULA, Land O Lakes, FL (US); Siarhei BARTOSHYK, Plano, TX (US); Padmapriya MAHALINGAM, McKinney, TX (US); Amalesh PRADHAN, Plano, TX (US)

(73) Assignee: JPMorgan Chase Bank, N.A., New York, NY (US)

(21) Appl. No.: 18/984,108

(22) Filed: Dec. 17, 2024

(51) Int. Cl. G06F 8/71; G06F 16/21

(52) U.S. Cl. CPC G06F 8/71; G06F 16/211

(57) ABSTRACT

Various methods and processes, apparatuses/systems, and media for registering schema for messaging are disclosed. A processor creates a schema for messaging, the schema having versions each defining a data structure outlining a format and a data type of a message to be published by a data publisher onto a CI/CD pipeline and to be consumed by a data consumer from the CI/CD pipeline; creates a file version of the schema; generates corresponding metadata for each version of the schema that explains that version of the schema; adds the metadata to the schema as a part of the schema for that file version of the schema; registers the schema onto a centralized schema registry; publishes, by the data publisher, the message corresponding to the registered schema onto the CI/CD pipeline; and queries by the metadata, by the data consumer, the centralized schema registry to consume the message from the CI/CD pipeline.

### TECHNICAL FIELD

This disclosure generally relates to data processing, and, more particularly, to methods and apparatuses for implementing a platform, language, cloud, and database agnostic schema registry module configured to register schema onto a centralized registry using metadata.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

In recent years, more and more computing applications are being implemented in distributed environments. A given distributed application may, for example, utilize numerous physical and/or virtualized servers spread among several data centers of a provider network, and may serve consumers in many different geographic locations. As the number of servers involved in a given application increases, and/or as the complexity of the application's network increases, during data streaming for both producer applications and consumer applications, failure events of various types (such as the apparent or real failures of processes or servers, substantial delays in network message latency, or loss of connectivity between pairs of servers) are inevitably encountered at higher rates.

For example, conventional public cloud schema registry may be a centralized service that allows users to manage and enforce data stream schemas so that the users may: discover, control, and evolve schemas in a centralized location; may share schemas between different systems, such as data producers and consumers, to improve communication and avoid errors; may change schemas over time while maintaining compatibility with previous versions; may ensure that data produced is continuously validated by a registered schema; and may improve end-to-end data quality and data governance.

In messaging between a producer application and a consumer application by utilizing conventional public cloud schema registry, it is assumed that the producer application and the consumer application must be located within the same geographic locations/regions with reference to datacenters. Otherwise, messaging may fail.

For example, schema version identifies (IDs) in various geographic locations may have different IDs. Let's assume a scenario that there are four geographical locations where a catalog with corresponding schema versions are embedded therein in each geographical location, and that a user is running a continuous integration/continuous delivery (CI/CD) pipeline to register the schemas over there.

However, it may be case that if a geographical location is not available and the pipeline is running, it might skip the version. Thus, the next version may get registered as the previous version that was skipped thereby creating a problem and system breakdown. So, one may not rely on the version number in all the clusters or geographic locations/regions whether on-premises or off-premises, because cross geographic location schema registry may return a different ID for the schema, resulting in a consumer application failing to parse the message; substantially increasing downtime for data migration from on-premises to any cloud; and substantially increasing downtime for data migration between any cloud platforms, etc.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic schema registry module configured to register schema onto a centralized registry using metadata, but the disclosure is not limited thereto. For example, the schema registry module disclosed herein may be configured to register schemas to a centralized schema registry using tags/metadata wherein the tags/metadata points to a schema and maps it to a Java archive (JAR) file version based on builds and validate, serialize/deserialize using schemas from the centralized schema registry or any other registry using tags/metadata instead of schema ID, thereby resulting in a consumer application successfully parsing the message published by a publisher application; “zero” downtime for data migration from on-premises to any cloud; “zero” downtime for data migration between any cloud platforms, etc., but the discloser is not limited thereto.

In some embodiments, a method for registering schema for messaging by utilizing one or more processors along with allocated memory is disclosed. The method may include: implementing a centralized schema registry; creating a schema for messaging, wherein the schema having versions each defining a data structure outlining a format and a data type of a message to be published by a data publisher onto a CI/CD pipeline and to be consumed by a data consumer from the CI/CD pipeline; creating a file version of the schema; generating corresponding metadata for each version of the schema that explains that version of the schema; adding the metadata to the schema as a part of the schema for that file version of the schema; registering the schema onto the centralized schema registry; publishing, by the data publisher, the message corresponding to the registered schema onto the CI/CD pipeline; and querying by the metadata, by the data consumer, the centralized schema registry to consume the message from the CI/CD pipeline.

In some embodiments, both the data publisher and the data consumer may be located within same geographic regions with respect to data centers' location.

In some embodiments, both the data publisher and the data consumer may be located in different geographic regions with respect to data centers' location.

In some embodiments, in creating the file version of the schema, the method may further include: creating a Java archive file version of the schema.

In some embodiments, the metadata points to the schema and maps the schema to the Java archive file version based on builds, wherein each build may correspond to a result of a process, implemented by the CI/CD pipeline, which may be a version of an application that is ready for testing or deployment.

In some embodiments, the method may further include: executing a serialization process or a deserialization process using the registered schema from the centralized schema registry using the metadata.

In some embodiments, the method may further include: validating data stream, for distributed applications running on a public cloud, using the registered schema from the centralized schema registry by using the metadata.

In some embodiments, a system for registering schema for messaging is disclosed. The system may include: a processor; and a memory operatively connected to the processor via a communication interface, the memory storing computer readable instructions, when executed, may cause the processor to: implement a centralized schema registry; create a schema for messaging, wherein the schema having versions each defining a data structure outlining a format and a data type of a message to be published by a data publisher onto a CI/CD pipeline and to be consumed by a data consumer from the CI/CD pipeline; create a file version of the schema; generate corresponding metadata for each version of the schema that explains that version of the schema; add the metadata to the schema as a part of the schema for that file version of the schema; register the schema onto the centralized schema registry; publish, by the data publisher, the message corresponding to the registered schema onto the CI/CD pipeline; and query by the metadata, by the data consumer, the centralized schema registry to consume the message from the CI/CD pipeline.

In some embodiments according to the system, both the data publisher and the data consumer may be located within same geographic regions with respect to data centers' location.

In some embodiments according to the system, both the data publisher and the data consumer may be located in different geographic regions with respect to data centers' location.

In some embodiments, in creating the file version of the schema, the processor may be further configured to: create a Java archive file version of the schema.

In some embodiments according to the system, the metadata points to the schema and maps the schema to the Java archive file version based on builds, wherein each build may correspond to a result of a process, implemented by the CI/CD pipeline, which may be a version of an application that is ready for testing or deployment.

In some embodiments, the processor may be further configured to: execute a serialization process or a deserialization process using the registered schema from the centralized schema registry using the metadata.

In some embodiments, the processor may be further configured to: validate data stream, for distributed applications running on a public cloud, using the registered schema from the centralized schema registry by using the metadata.

In some embodiments, a non-transitory computer readable medium configured to store instructions is disclosed. The instructions, when executed, may cause a processor to perform the following: implementing a centralized schema registry; creating a schema for messaging, wherein the schema having versions each defining a data structure outlining a format and a data type of a message to be published by a data publisher onto a CI/CD pipeline and to be consumed by a data consumer from the CI/CD pipeline; creating a file version of the schema; generating corresponding metadata for each version of the schema that explains that version of the schema; adding the metadata to the schema as a part of the schema for that file version of the schema; registering the schema onto the centralized schema registry; publishing, by the data publisher, the message corresponding to the registered schema onto the CI/CD pipeline; and querying by the metadata, by the data consumer, the centralized schema registry to consume the message from the CI/CD pipeline.

In some embodiments according to the non-transitory computer readable medium, both the data publisher and the data consumer may be located within same geographic regions with respect to data centers' location.

In some embodiments according to the non-transitory computer readable medium, both the data publisher and the data consumer may be located in different geographic regions with respect to data centers' location.

In some embodiments, in creating the file version of the schema, the instructions, when executed, may cause the processor to further perform the following: creating a Java archive file version of the schema.

In some embodiments according to the non-transitory computer readable medium, the metadata points to the schema and maps the schema to the Java archive file version based on builds, wherein each build may correspond to a result of a process, implemented by the CI/CD pipeline, which may be a version of an application that is ready for testing or deployment.

In some embodiments, the instructions, when executed, may cause the processor to further perform the following: executing a serialization process or a deserialization process using the registered schema from the centralized schema registry using the metadata.

In some embodiments, the instructions, when executed, may cause the processor to further perform the following: validating data stream, for distributed applications running on a public cloud, using the registered schema from the centralized schema registry by using the metadata.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic schema registry module configured to register schema onto a centralized registry using metadata in accordance with an embodiment.

FIG. 2 illustrates a diagram of a network environment with a platform, language, database, and cloud agnostic schema registry device in accordance with an embodiment.

FIG. 3 illustrates a system diagram for implementing a platform, language, database, and cloud agnostic schema registry device having a platform, language, database, and cloud agnostic schema registry module in accordance with an embodiment.

FIG. 4 illustrates a system diagram for implementing a platform, language, database, and cloud agnostic schema registry module of FIG. 3 in accordance with an embodiment.

FIG. 5 a flow chart of a process implemented by the platform, language, database, and cloud agnostic schema registry module of FIG. 4 for registering schema onto a centralized registry using metadata in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As mentioned earlier, a given distributed application may, for example, utilize numerous physical and/or virtualized servers spread among several data centers of a provider network, and may serve consumers in many different geographic locations. For example, conventional public cloud schema registry may be a centralized service that allows users to manage and enforce data stream schemas so that the users may: discover, control, and evolve schemas in a centralized location; may share schemas between different systems, such as data producers and consumers, to improve communication and avoid errors; may change schemas over time while maintaining compatibility with previous versions; may ensure that data produced is continuously validated by a registered schema; and may improve end-to-end data quality and data governance.

In messaging between a producer application and a consumer application by utilizing conventional public cloud schema registry, it is assumed that the producer application and the consumer application must be located within the same geographic locations/regions with reference to datacenters. Otherwise, messaging may fail.

For example, schema version IDs in various geographic locations may have different IDs. Let's assume a scenario that there are four geographical locations where a catalog with corresponding schema versions are embedded therein in each geographical location, and that a user is running a CI/CD pipeline to register the schemas over there.

However, as mentioned earlier, it may be case that if a geographical location is not available and the pipeline is running, it might skip the version. Thus, the next version may get registered as the previous version that was skipped thereby creating a problem and system breakdown. So, one may not rely on the version number in all the clusters or geographic locations/regions whether on-premises or off-premises, because cross geographic location schema registry may return a different ID for the schema, resulting in a consumer application failing to parse the message; substantially increasing downtime for data migration from on-premises to any cloud; and substantially increasing downtime for data migration between any cloud platforms, etc.

The present disclosure, through one or more of its various aspects, embodiments, and/or specific features or sub-components, provides, among other features, various systems, servers, devices, methods, media, programs, and platforms for implementing a platform, language, cloud, and database agnostic schema registry module configured to register schema onto a centralized registry using metadata, but the disclosure is not limited thereto. For example, the schema registry module disclosed herein may be configured to register schemas to a centralized schema registry using tags/metadata wherein the tags/metadata points to a schema and maps it to a JAR file version based on builds and validate, serialize/deserialize using schemas from the centralized schema registry or any other registry using the tags/metadata instead of schema ID, thereby resulting in a consumer application successfully parsing the message published by a publisher application; “zero” downtime for data migration from on-premises to any cloud; “zero” downtime for data migration between any cloud platforms, etc., but the discloser is not limited thereto.

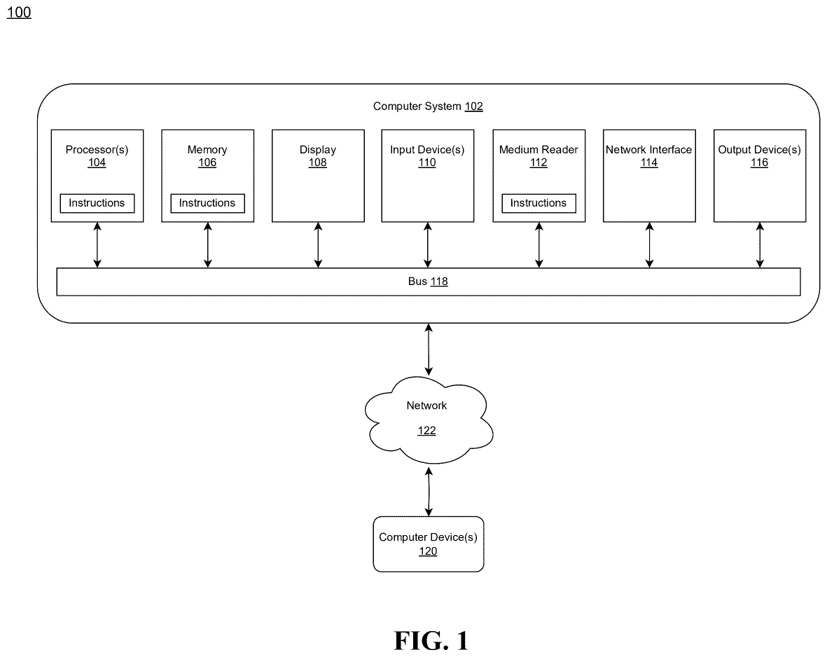

FIG. 1 is an exemplary system 100 for use in implementing a platform, language, database, and cloud agnostic schema registry module configured to register schema onto a centralized registry using metadata in accordance with an exemplary embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the schema registry module may be platform, language, database, and cloud agnostic that may allow for consistent easy orchestration and passing of data through various components to output a desired result regardless of platform, browser, language, database, and cloud environment. Since the disclosed process, in some embodiments, may be platform, language, database, browser, and cloud agnostic, the schema registry module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionalities as described herein, and a processor described herein may be used to support a virtual processing environment.

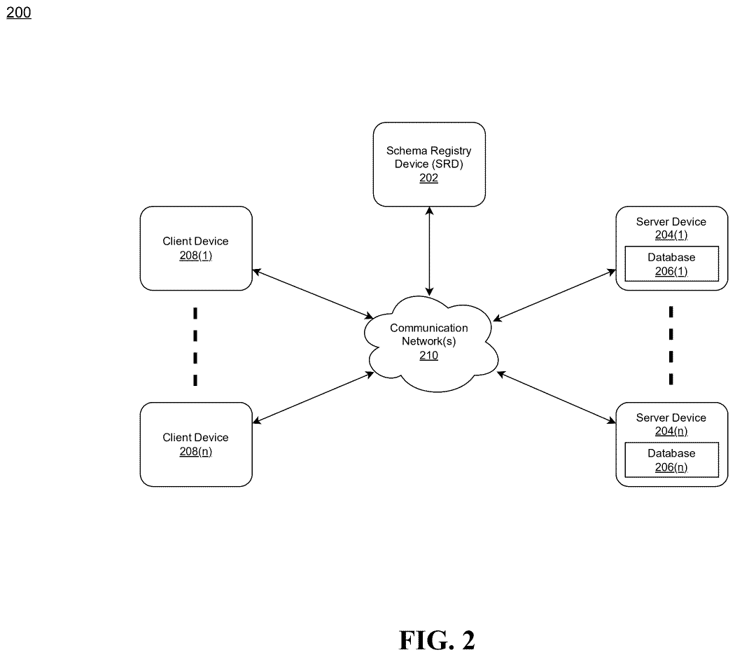

Referring to FIG. 2, a schematic of an exemplary network environment 200 for implementing a language, platform, database, and cloud agnostic schema registry device (SRD) of the instant disclosure is illustrated.

In some embodiments, the above-described problems associated with conventional tools may be overcome by implementing an SRD 202 as illustrated in FIG. 2 that may be configured for implementing a platform, language, database, and cloud agnostic schema registry module configured to register schema onto a centralized registry using metadata, but the disclosure is not limited thereto. For example, the SRD 202 disclosed herein may be configured to register schemas to a centralized schema registry using tags/metadata wherein the tags/metadata points to a schema and maps it to a Java archive (JAR) file version based on builds and validate, serialize/deserialize using schemas from the centralized schema registry or any other registry using tags/metadata instead of schema ID, thereby resulting in a consumer application successfully parsing the message published by a publisher application; “zero” downtime for data migration from on-premises to any cloud; “zero” downtime for data migration between any cloud platforms, etc., but the discloser is not limited thereto.

The SRD 202 may have one or more computer system 102s, as described with respect to FIG. 1, which in aggregate provide the necessary functions.

The SRD 202 may store one or more applications that may include executable instructions that, when executed by the SRD 202, cause the SRD 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the SRD 202 itself, may be located in virtual server(s) running in a cloud-based computing environment rather than being tied to one or more specific physical network computing devices. Also, the application(s) may be running in one or more virtual machines (VMs) executing on the SRD 202. Additionally, in one or more embodiments of this technology, virtual machine(s) running on the SRD 202 may be managed or supervised by a hypervisor.

In the network environment 200 of FIG. 2, the SRD 202 may be coupled to a plurality of server devices 204(1)-204(n) that hosts a plurality of databases 206(1)-206(n), and also to a plurality of client devices 208(1)-208(n) via communication network(s) 210. A communication interface of the SRD 202, such as the network interface 114 of the computer system 102 of FIG. 1, operatively couples and communicates between the SRD 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the SRD 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus will not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The SRD 202 may be a standalone device or integrated with one or more other devices or apparatuses, such as one or more of the server devices 204(1)-204(n). In some embodiments, the SRD 202 may be hosted by one of the server devices 204(1)-204(n), and other arrangements may also be possible. Moreover, one or more of the devices of the SRD 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the SRD 202 via the communication network(s) 210 according to the HTTP-based and/or JavaScript Object Notation (JSON) protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the SRD 202 that may efficiently provide a platform for implementing a platform, language, database, and cloud agnostic schema registry module configured to register schema onto a centralized registry using metadata, but the disclosure is not limited thereto. For example, the client devices 208(1)-208(n) in this example may include any type of computing device that may facilitate the implementation of the SRD 202 that may efficiently provide a platform for implementing a platform, language, database, and cloud agnostic schema registry module configured to register schemas to a centralized schema registry using tags/metadata wherein the tags/metadata points to a schema and maps it to a JAR file version based on builds and validate, serialize/deserialize using schemas from the centralized schema registry or any other registry using tags/metadata instead of schema ID, thereby resulting in a consumer application successfully parsing the message published by a publisher application; “zero” downtime for data migration from on-premises to any cloud; “zero” downtime for data migration between any cloud platforms, etc., but the discloser is not limited thereto.

The client devices 208(1)-208(n) may run interface applications, such as standard web browsers or standalone client applications, which may provide an interface to communicate with the SRD 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the SRD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the SRD 202, the server devices 204(1)-204(n), or the client devices 208(1)-208(n), in some embodiments, may be configured to operate as virtual instances on the same physical machine. In some embodiments, one or more of the SRD 202, the server devices 204(1)-204(n), or the client devices 208(1)-208(n) may operate on the same physical device rather than as separate devices communicating through communication network(s) 210. Additionally, there may be more or fewer SRDs 202, server devices 204(1)-204(n), or client devices 208(1)-208(n) than illustrated in FIG. 2. In some embodiments, the SRD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

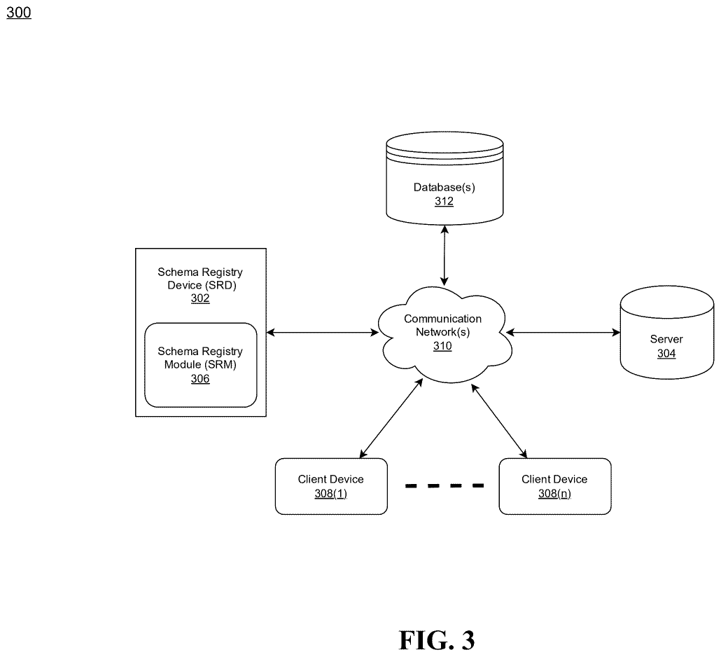

FIG. 3 illustrates a system diagram for implementing a platform, language, and cloud agnostic SRD having a platform, language, database, and cloud agnostic schema registry module (SRM) in accordance with an embodiment.

As illustrated in FIG. 3, the system 300 may include an SRD 302 within which an SRM 306 may be embedded, a server 304, a database(s) 312, a plurality of client devices 308(1) . . . 308(n), and a communication network 310.

In some embodiments, the SRD 302 including the SRM 306 may be connected to the server 304, and the database(s) 312 via the communication network 310. The SRD 302 may also be connected to the plurality of client devices 308(1) . . . 308(n) via the communication network 310, but the disclosure is not limited thereto.

According to exemplary embodiment, the SRD 302 is described and shown in FIG. 3 as including the SRM 306, although it may include other rules, policies, modules, databases, or applications, etc. In some embodiments, the database(s) 312 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto.

In some embodiments, the SRM 306 may be configured to receive real-time feed of data from the plurality of client devices 308(1) . . . 308(n) and secondary sources via the communication network 310.

As may be described below, the SRM 306 may be configured to: implement a centralized schema registry; create a schema for messaging, wherein the schema having versions each defining a data structure outlining a format and a data type of a message to be published by a data publisher onto a CI/CD pipeline and to be consumed by a data consumer from the CI/CD pipeline; create a file version of the schema; generate corresponding metadata for each version of the schema that explains that version of the schema; add the metadata to the schema as a part of the schema for that file version of the schema; register the schema onto the centralized schema registry; publish, by the data publisher, the message corresponding to the registered schema onto the CI/CD pipeline; and query by the metadata, by the data consumer, the centralized schema registry to consume the message from the CI/CD pipeline, but the disclosure is not limited thereto.

The plurality of client devices 308(1) . . . 308(n) are illustrated as being in communication with the SRD 302. In this regard, the plurality of client devices 308(1) . . . 308(n) may be “clients” (e.g., customers) of the SRD 302 and are described herein as such. Nevertheless, it is to be known and understood that the plurality of client devices 308(1) . . . 308(n) need not necessarily be “clients” of the SRD 302, or any entity described in association therewith herein. Any additional or alternative relationship may exist between either or both of the plurality of client devices 308(1) . . . 308(n) and the SRD 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the SRD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The SRD 302 may be the same or similar to the SRD 202 as described with respect to FIG. 2, including any features or combination of features described with respect thereto.

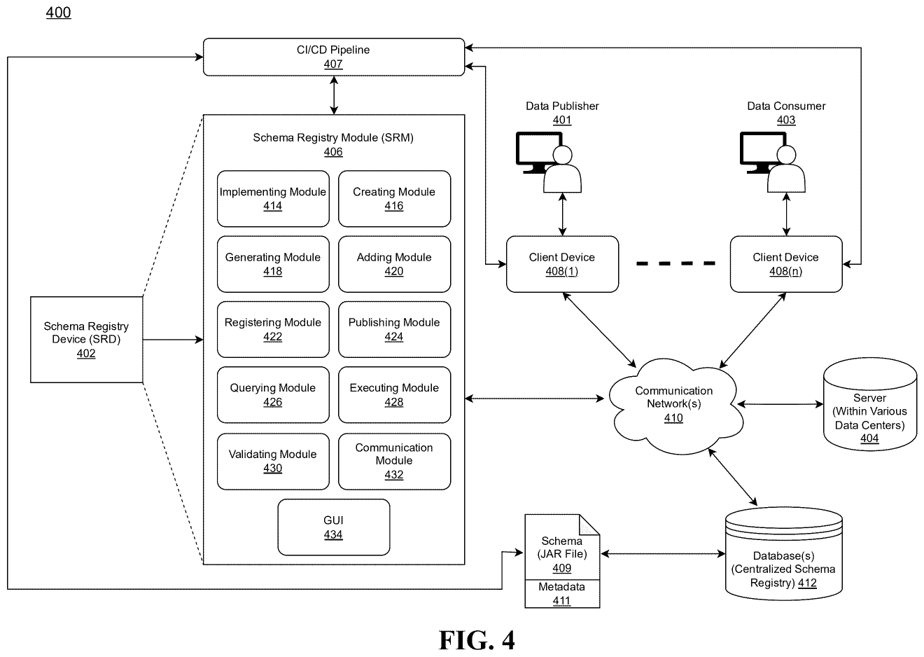

FIG. 4 illustrates a system diagram for implementing a platform, language, database, and cloud agnostic SRM of FIG. 3 in accordance with an exemplary embodiment.

In some embodiments, the system 400 may include a platform, language, database, and cloud agnostic SRD 402 within which a platform, language, database, and cloud agnostic SRM 406 may be embedded, a server 404, a CI/CD pipeline 407, database(s) 412, and a communication network 410. In some embodiments, server 404 may comprise a plurality of servers located centrally or located in different geographic locations with respect to data centers' locations, but the disclosure is not limited thereto.

In some embodiments, the SRD 402 including the SRM 406 may be connected to the server 404, the integration framework 407, and the database(s) 412 via the communication network 410. The SRD 402 may also be connected to the plurality of client devices 408(1)-408(n) via the communication network 410, but the disclosure is not limited thereto. Client device 408(1) may be utilized by a data publisher 401, and client device 408(n) may be utilized by a data consumer, but the disclosure is not limited thereto. The SRM 406, the server 404, the plurality of client devices 408(1)-408(n), the database(s) 412, the communication network 410 as illustrated in FIG. 4 may be the same or similar to the SRM 306, the server 304, the plurality of client devices 308(1)-308(n), the database(s) 312, the communication network 310, respectively, as illustrated in FIG. 3. Moreover, the database(s) 412 may be a centralized schema registry that may be utilized by both the data publisher 401 and the data consumer 403.

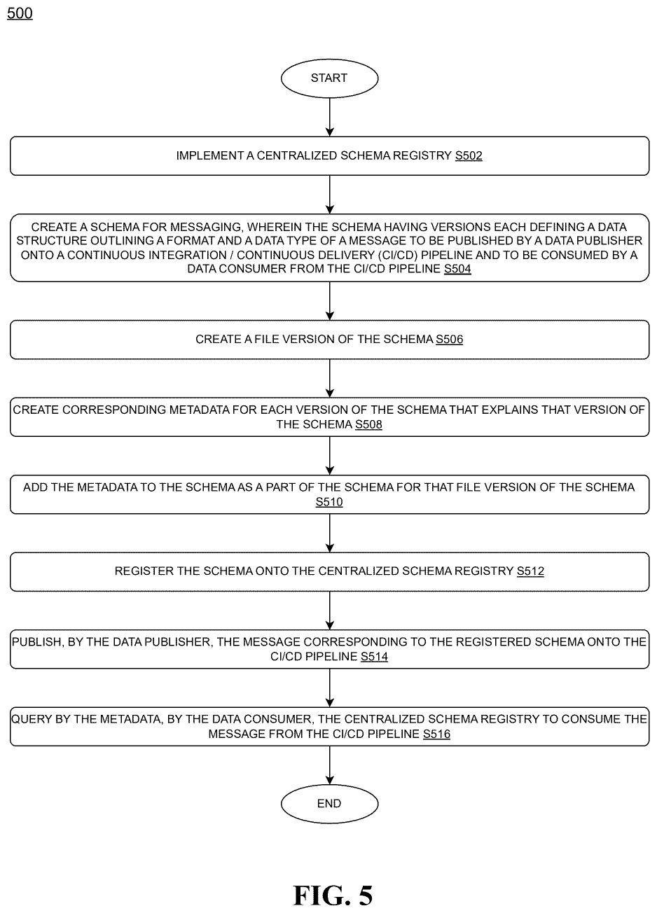

In some embodiments, as illustrated in FIG. 4, the SRM 406 may include an implementing module 414, a creating module 416, a generating module 418, an adding module 420, a registering module 422, a publishing module 424, a querying module 426, an executing module 428, a validating module 430, a communication module 432, and a Graphical User Interface (GUI) 434. In some embodiments, interactions and data exchange among these modules included in the SRM 406 provide the advantageous effects of the disclosed invention. Functionalities of each module of FIG. 4 may be described in detail below with reference to FIGS. 4-5.

In some embodiments, each of the implementing module 414, creating module 416, generating module 418, adding module 420, registering module 422, publishing module 424, querying module 426, executing module 428, validating module 430, and the communication module 432 of the SRM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the implementing module 414, creating module 416, generating module 418, adding module 420, registering module 422, publishing module 424, querying module 426, executing module 428, validating module 430, and the communication module 432 of the SRM 406 of FIG. 4 may be implemented by microprocessors or similar, and may be programmed using software (e.g., microcode) to perform various functions discussed herein and may optionally be driven by firmware and/or software.

Alternatively, in some embodiments, each of implementing module 414, creating module 416, generating module 418, adding module 420, registering module 422, publishing module 424, querying module 426, executing module 428, validating module 430, and the communication module 432 of the SRM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the SRM 406 of FIG. 4 may also be implemented by cloud-based deployment. In some embodiments, a single API call may invoke each of the implementing module 414, creating module 416, generating module 418, adding module 420, registering module 422, publishing module 424, querying module 426, executing module 428, validating module 430, and the communication module 432 of the SRM 406 of FIG. 4 (in complete or in part) either sequentially or parallelly based on flow design, but the disclosure is not limited thereto.

In some embodiments, each of implementing module 414, creating module 416, generating module 418, adding module 420, registering module 422, publishing module 424, querying module 426, executing module 428, validating module 430, and the communication module 432 of the SRM 406 of FIG. 4 may be called via corresponding API, but the disclosure is not limited thereto. For example, in some embodiments, the implementing module 414 may be called via a first API, the creating module 416 may be called via a second API, the generating module 418 may be called via a third API, the adding module 420 may be called via a fourth API, the registering module 422 may be called via a fifth API, the publishing module 424 may be called via a sixth API, the querying module 426 may be called via a seventh API, the executing module 428 may be called via an eight API, the validating module 430 may called via a ninth API, and the communication module 432 may be called via a tenth API. In some embodiments, calls may also be made using event-based message interfaces in addition to APIs. An event-based message interface may be a design pattern that enables communication between services by defining events and handlers that process them. This approach may allow for efficient communication and decoupled components, which may lead to more flexible and modular systems.

In some embodiments, the process implemented by the SRM 406 may be executed via the communication module 432, and the communication network 410, which may comprise plural networks as described above. In some embodiments, in an exemplary embodiment, the various components of the SRM 406 may communicate with the server 404, and the database(s) 412 via the communication module 436 and the communication network 410 and the results may be displayed onto the GUI 434. Of course, these embodiments are merely exemplary and are not limiting or exhaustive. The database(s) 412 may include the databases included within the private cloud and/or public cloud and the server 404 may include one or more servers within the private cloud and the public cloud within same or different geographic locations/regions.

FIG. 5 illustrates a flow chart of a process 500 implemented by the platform, language, database, and cloud agnostic SRM 406 of FIG. 4 for registering schema onto a centralized registry using metadata in accordance with an embodiment. It may be appreciated that the illustrated process 500 and associated steps may be performed in a different order, with illustrated steps omitted, with additional steps added, or with a combination of reordered, combined, omitted, or additional steps.

The present disclosure, through one or more of its various aspects, embodiments, and/or specific features or sub-components, provides, among other features, various systems, servers, devices, methods, media, programs, and platforms for implementing the platform, language, cloud, and database agnostic SRM 406 of FIG. 4 may be configured to register schema onto the centralized schema registry (i.e., database 412) using metadata, but the disclosure is not limited thereto. For example, the SRM 406 disclosed herein with respect to FIGS. 4-5 may be configured to register schemas to the centralized schema registry 412 using tags/metadata wherein the tags/metadata points to a schema 409 and maps it to a JAR file version based on builds and validate, serialize/deserialize using schemas from the centralized schema registry 412 or any other registry using the tags/metadata instead of schema ID, thereby resulting in a consumer application successfully parsing the message published by a publisher application; “zero” downtime for data migration from on-premises to any cloud; “zero” downtime for data migration between any cloud platforms, etc., but the discloser is not limited thereto.

For example, referring to FIGS. 4-5, in some embodiments, at step S502, the process 500 implemented by the SRM 406 may include implementing, by calling the implementing module 414 via the first API, the centralized schema registry via the communication network(s) 410 and the communication module 432.

In some embodiments, at step S504, the process 500 implemented by the SRM 406 may include creating by calling the creating module 416 via the second API, a schema 409 for messaging. The schema 409 having versions each defining a data structure outlining a format and a data type of a message to be published by a data publisher 401 onto the CI/CD pipeline 407 and to be consumed by a data consumer 403 from the CI/CD pipeline 407.

In some embodiments, at step S506, the process 500 implemented by the SRM 406 may include creating by calling the creating module 416 via the second API, a file version of the schema 409. In some embodiments, in creating the file version of the schema 409, at step S506, the process 500 may further include creating a JAR file version of the schema 409.

In some embodiments, at step S508, the process 500 implemented by the SRM 406 may include generating by calling the generating module 418 via the third API, corresponding metadata 411 for each version of the schema 409 that explains that version of the schema 409. In some embodiments, the metadata 411 may point to the schema and maps the schema 409 to the JAR file version based on builds. Each build may correspond to a result of a process, implemented by the CI/CD pipeline 407, which may be a version of an application that is ready for testing or deployment. In some embodiments, when a message mentioned above is performed on this CI/CD pipeline 407, a number of rules may be triggered to execute on the SRM 406 as well. For example, a candidate fix build may be executed on the consumer application itself. In another example, a properly built CI/CD pipeline 407 may perform a developer-defined unit test and/or self-test on the state of the system (i.e., the SRM 406). In some embodiments, these additional tests may trigger a deployment of the newly repaired application.

For example, when someone is requesting a message via the SRM 406 that I need a particular business record, the SRM 406 may create the schema 409 for that business record and run the created schema 409 onto the CI/CD pipeline 407 and trigger builds. Once that is done, the schema 409 may be picked up and certain JAR file may be created out of it so that it may be used as a dependency in all the services that are going to use it to publish the message. The producers, i.e., data publisher may actually put that JAR file as dependency, thereby resulting a symphony of microservices-all the microservices are synchronized from the beginning and to the end of a production cycle, avoiding the possibilities of scenarios where all publishers and/or consumers are speaking their own language, their own interpretation of the message creating a total system failure.

However, the process 600 as implemented by the SRM 406 herein, results an efficient messaging where, once the schema 409 along with its metadata 411 is registered at the CI/CD pipeline 407, a JAR file is created, and kept in the centralized schema registry 412, so that everyone may access from that centralized schema registry 412. Thus, the data publisher 401 may pick up a version independent of where the consumers are. The publisher 401 may publish the messages based on that. Data consumer 403 might be two versions behind, but that is irrelevant. For example, the data consumer 403 may pick up their work, and upgrade on their own pace and say I am consuming this message now. Or vice a versa. For example, the data consumer 403 may say I don't care when the message is going to come. I am now adding five columns based on new schemas and I need it now. And for producers (i.e., data producer 401), you are free, based on when you go live with those features, publish this message and I am ready to capture my position.

In some embodiments, at step S510, the process 500 implemented by the SRM 406 may include adding by calling the adding module 420 via the fourth API, the metadata 411 to the schema 409 as a part of the schema 409 for that JAR file version of the schema 409.

In some embodiments, at step S512, the process 500 implemented by the SRM 406 may include registering by calling the registering module 422 via the fifth API, the schema 409 onto the centralized schema registry 412.

In some embodiments, at step S514, the process 500 implemented by the SRM 406 may include publishing by calling the publishing module 424 via the sixth API, by the data publisher 401, the message corresponding to the registered schema 409 onto the CI/CD pipeline 407.

The data publisher 401 is mainly focused on a business record schema of a JAR version. That is, by utilizing the SRM 406, the data publisher 401 may execute a request by stating that I am a publisher of this JAR version and give me my schema by my JAR file version wherever I go (i.e., whether the data publisher 401 is on public cloud (e.g., AWS), on-premises, Google®, Azule®, etc.). Thus, it may become a solution for a financial industry where the schemas are by JAR and whichever place they go, they can interpret a message, and they may actually create a message without worrying about system failure.

In some embodiments, at step S516, the process 500 implemented by the SRM 406 may include querying by the metadata 411 by calling the querying module 426 via the seventh API, by the data consumer 403, the centralized schema registry 412 to consume the message from the CI/CD pipeline 407. In some embodiments, at step S516, the process 500 implemented by the SRM 406 may further include executing, by calling the executing module 428 via the eighth API, a serialization process or a deserialization process using the registered schema from the centralized schema registry 412 using the metadata 411. In some embodiments, at step S516, the process 500 implemented by the SRM 406 may further include validating by calling the validating module 430 via the ninth API, data stream, for distributed applications running on a public cloud, using the registered schema (i.e., JAR file version) 409 from the centralized schema registry 412 by using the metadata 411. In some embodiments, both the data publisher 401 and the data consumer 403 may be located within same geographic regions with respect to data centers' location. In some embodiments, both the data publisher 401 and the data consumer 403 may be located in different geographic regions with respect to data centers' location.

Data validation may prove to be a pivotal step in building data pipelines to ensure that the data being ingested, processed, and outputted maintains its quality, accuracy, and consistency. Using Python for data validation when building data pipelines may be a wise choice due to its rich library ecosystem and flexibility. With tools ranging from built-in functions to specialized libraries like Pandas, Python makes it easy to enforce data quality at every step of your data pipeline, ensuring the reliability and accuracy of one's analyses and applications.

In some embodiments, metadata 411 may refer to a broad class of information relating to a content object, and it may apply to a broad class of content objects, including both physical and electronic objects. The metadata 411 may also include an instruction or set of instructions (possibly distributed over one or more devices) that may be executed by machine or machines to perform a behavior associated with an object (e.g., perform an on-line transaction, transmit or transfer content, authenticate/verify a user, content, access token, update/patch a program etc.). The metadata 411 may be formatted and stored in a variety of formats. One format is XML, but there are others. The metadata 411 for a particular content object may be distributed over different storage devices. In such a distributed storage approach, the metadata 411 in one location may include references to metadata in other locations (such an index, pointer, address, URL, etc.).

Moreover, with respect to a messaging system, it is desired to have a place which has high availability and a throughput where anyone who is querying for this centralized schema registry 412 is always available. Thus, if everyone is storing at their own places and they have their own interpretations of how to interpret the schemas then it is decentralized and then resulting in situation of packets where things may not work the way they should be. For example, if interpretation is little different, then there appears to be a huge challenge. In this instant use case, because it is a financial records one is dealing with, everyone speaks the same language. Thus, it does not matter how the team changes overtime, the point is that the code is available, and it is always referencing the single place, the centralized schema registry 412. Thus, teams may change, people may change, technology stacks may change, but the reference to the schema 409 is in one place, the centralized schema registry 412. Thus, everyone knows what they are dealing with all the time. Even though, it may be file-based, everyone is always referring to the same schema packaging over millions of records together. For example, whether it is a distributed system message, or whether it is a single message flowing, the process 500 implemented by the SRM 406 is always referring to the same schema registry, i.e., the centralized schema registry 412 (everyone has the same agreements; it may be the medium or the volume that may be changing), thereby easily executing serialization/deserialization using schemas from the centralized schema registry 412 or any other registry using tags/metadata instead of schema ID.

For example, as mentioned earlier, it may be case that if a geographical location is not available and the CI/CD pipeline 407 is running, it might skip the version. Thus, the next version may get registered as the previous version that was skipped thereby creating a problem and system breakdown. So, one may not rely on the version number in all the clusters or geographic locations/regions whether on-premises or off-premises, because cross geographic location schema registry may return a different ID for the schema, resulting in the data consumer 403 failing to parse the message; substantially increasing downtime for data migration from on-premises to any cloud; and substantially increasing downtime for data migration between any cloud platforms, etc.

Thus, one may not rely on the version number in all the clusters or geographic regions whether on-premises or off-premises. The SRM 406 disclosed herein relies on the metadata 411. Thus, it does not matter which sequence the schemas were registered—the SRM 406 queries the schema 409 via the JAR file version—that is when the schema 409 is registered onto the centralized schema registry 412, the SRM 406 adds the metadata 411 out there with the version of that particular schema of that JAR file in the metadata 411, and when a query is made, it is made by the subject name (i.e., 1.2.74) stating give me the schema for that. Thus, the library that is being created by the SRM 406 is creating to interact with this catalog makes it catalog agnostic—it is going to make a call to the centralized schema registry, get this schema 409, and encrypt based on that to publish the message. And the same process is executed by the SRM 406 when the interpreter goes to read the message it bypasses the versions, it bypasses schema IDs over there and goes to query by the JAR file and then it queries to get the ID based on the JAR file (for both on-premises (i.e., private cloud) or off-premises (i.e., public cloud)). Thus, the metadata part and the tag part of the schema 409 is adding more information which is connecting it to the created JAR files, thereby connecting it to the type of schemas (business records).

The schema 409 is not just a structured data structure that is being published. Rather, the SRM 406 may be configured to create these schemas as if they are of business records. For example, an employee X may be heading the payment group—they are driving all the payment related publication of messages via the CI/CD pipeline 407. Thus, assume a use case scenario, where a card is swapped somewhere, and it comes to employee X′ domain. The employee X may execute a payment approved or a payment closed process. Thus, the messages they are publishing to each other actually are schemas referred to as business records. Thus, every process that is being executed in this domain, it may be interpreted as a business record.

In some embodiments, for each attribute, within this domain, a protection group may be added by the SRM 406 to the centralized schema registry 412 as well in terms of metadata so that it is not only available inside the schema 409, but if someone is browsing the schema 409, may actually know what is coming their way. There may be a space in the metadata 411 that may define what kind of business record it is—meaning depending on which geographic location, this could be published when it is a part of a message, but the schema 409 may give that place holder where the data publisher 401 puts a value, and based on that, the data consumer 403 actually puts the retention part of the message (i.e., these are the three to four things that we have packaged inside it. And these are the values are what we are going to add as metadata of the schemas 409).

Thus, as disclosed above with reference to FIGS. 4-5, the SRM 406 disclosed herein may be configured to register schemas to a centralized schema registry using tags/metadata wherein the tags/metadata points to a schema and maps it to a JAR file version based on builds and validate, serialize/deserialize using schemas from the centralized schema registry or any other registry using tags/metadata instead of schema ID, thereby resulting in a consumer application successfully parsing the message published by a publisher application; “zero” downtime for data migration from on-premises to any cloud; “zero” downtime for data migration between any cloud platforms, etc., but the discloser is not limited thereto.

In some embodiments, the SRD 402 may include a memory (e.g., a memory 106 as illustrated in FIG. 1) which may be a non-transitory computer readable medium that may be configured to store instructions for implementing a platform, language, database, and cloud agnostic SRM 406 for registering schema onto a centralized registry using metadata as disclosed herein. The SRD 402 may also include a medium reader (e.g., a medium reader 112 as illustrated in FIG. 1) which may be configured to read any one or more sets of instructions, e.g., software, from any of the memories described herein. The instructions, when executed by a processor embedded within the SRM 406 or within the SRD 402, may be used to perform one or more of the processes as described herein. In a particular embodiment, the instructions may reside completely, or at least partially, within the memory 106, the medium reader 112, and/or the processor 104 (see FIG. 1) during execution by the SRD 402.

In some embodiments, the instructions, when executed, may cause a processor embedded within the SRM 406 or the SRD 402 to perform the following: implementing a centralized schema registry; creating a schema for messaging, wherein the schema having versions each defining a data structure outlining a format and a data type of a message to be published by a data publisher onto a CI/CD pipeline and to be consumed by a data consumer from the CI/CD pipeline; creating a file version of the schema; generating corresponding metadata for each version of the schema that explains that version of the schema; adding the metadata to the schema as a part of the schema for that file version of the schema; registering the schema onto the centralized schema registry; publishing, by the data publisher, the message corresponding to the registered schema onto the CI/CD pipeline; and querying by the metadata, by the data consumer, the centralized schema registry to consume the message from the CI/CD pipeline. In some embodiments, the processor may be the same or similar to the processor 104 as illustrated in FIG. 1 or the processor embedded within the SRD 202, SRD 302, SRD 402, and SRM 406 which may be the same or similar to the processor 104.

In some embodiments according to the non-transitory computer readable medium, both the data publisher and the data consumer may be located within same geographic regions with respect to data centers' location.

In some embodiments according to the non-transitory computer readable medium, both the data publisher and the data consumer may be located in different geographic regions with respect to data centers' location.

In some embodiments, in creating the file version of the schema, the instructions, when executed, may cause the processor 104 to further perform the following: creating a JAR file version of the schema.

In some embodiments according to the non-transitory computer readable medium, the metadata points to the schema and maps the schema to the JAR file version based on builds, wherein each build may correspond to a result of a process, implemented by the CI/CD pipeline, which may be a version of an application that is ready for testing or deployment.

In some embodiments, the instructions, when executed, may cause the processor 104 to further perform the following: executing a serialization process or a deserialization process using the registered schema from the centralized schema registry using the metadata.

In some embodiments, the instructions, when executed, may cause the processor 104 to further perform the following: validating data stream, for distributed applications running on a public cloud, using the registered schema from the centralized schema registry by using the metadata.

In some embodiments as disclosed above in FIGS. 1-5, technical improvements effected by the instant disclosure may include a platform for implementing a platform, language, database, and cloud agnostic schema registry module configured to register schema onto a centralized registry using metadata, but the disclosure is not limited thereto. For example, as disclosed above in FIGS. 1-5, technical improvements effected by the instant disclosure may include a platform for implementing a platform, language, database, and cloud agnostic schema registry module configured to register schemas to a centralized schema registry using tags/metadata wherein the tags/metadata points to a schema and maps it to a JAR file version based on builds and validate, serialize/deserialize using schemas from the centralized schema registry or any other registry using tags/metadata instead of schema ID, thereby resulting in a consumer application successfully parsing the message published by a publisher application; “zero” downtime for data migration from on-premises to any cloud; “zero” downtime for data migration between any cloud platforms, etc., but the discloser is not limited thereto.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, method, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or method described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for registering schema for messaging by utilizing one or more processors along with allocated memory, the method comprising:
implementing a centralized schema registry;
creating a schema for messaging, wherein the schema having versions each defining a data structure outlining a format and a data type of a message to be published by a data publisher onto a continuous integration/continuous delivery (CI/CD) pipeline and to be consumed by a data consumer from the CI/CD pipeline;
creating a file version of the schema;
generating corresponding metadata for each version of the schema that explains that version of the schema;
adding the metadata to the schema as a part of the schema for that file version of the schema;
registering the schema onto the centralized schema registry;
publishing, by the data publisher, the message corresponding to the registered schema onto the CI/CD pipeline; and
querying by the metadata, by the data consumer, the centralized schema registry to consume the message from the CI/CD pipeline.

2. The method of claim 1, wherein both the data publisher and the data consumer are located within same geographic regions with respect to data centers' location.

3. The method of claim 1, wherein both the data publisher and the data consumer are located in different geographic regions with respect to data centers' location.

4. The method of claim 1, wherein in creating the file version of the schema, the method further comprising:
creating a Java archive file version of the schema.

5. The method of claim 4, wherein the metadata points to the schema and maps the schema to the Java archive file version based on builds, wherein each build corresponds to a result of a process, implemented by the CI/CD pipeline, which is a version of an application that is ready for testing or deployment.

6. The method of claim 4, further comprising:
executing a serialization process or a deserialization process using the registered schema from the centralized schema registry using the metadata.

7. The method of claim 1, further comprising:
validating data stream, for distributed applications running on a public cloud, using the registered schema from the centralized schema registry by using the metadata.

8. A system for registering schema for messaging, the system comprising:
a processor; and
a memory operatively connected to the processor via a communication interface, the memory storing computer readable instructions, when executed, causes the processor to:
implement a centralized schema registry;
create a schema for messaging, wherein the schema having versions each defining a data structure outlining a format and a data type of a message to be published by a data publisher onto a continuous integration/continuous delivery (CI/CD) pipeline and to be consumed by a data consumer from the CI/CD pipeline;
create a file version of the schema;
generate corresponding metadata for each version of the schema that explains that version of the schema;
add the metadata to the schema as a part of the schema for that file version of the schema;
register the schema onto the centralized schema registry;
publish, by the data publisher, the message corresponding to the registered schema onto the CI/CD pipeline; and
query by the metadata, by the data consumer, the centralized schema registry to consume the message from the CI/CD pipeline.

9. The system of claim 8, wherein both the data publisher and the data consumer are located within same geographic regions with respect to data centers' location.

10. The system of claim 8, wherein both the data publisher and the data consumer are located in different geographic regions with respect to data centers' location.

11. The system of claim 8, wherein in creating the file version of the schema, the processor is further configured to:
create a Java archive file version of the schema.

12. The system of claim 11, wherein the metadata points to the schema and maps the schema to the Java archive file version based on builds, wherein each build corresponds to a result of a process, implemented by the CI/CD pipeline, which is a version of an application that is ready for testing or deployment.

13. The system of claim 11, wherein the processor is further configured to:
execute a serialization process or a deserialization process using the registered schema from the centralized schema registry using the metadata.

14. The system of claim 8, wherein the processor is further configured to:
validate data stream, for distributed applications running on a public cloud, using the registered schema from the centralized schema registry by using the metadata.

15. A non-transitory computer readable medium configured to store instructions for registering schema for messaging, wherein the instructions, when executed, cause a processor to perform the following:
implementing a centralized schema registry;
creating a schema for messaging, wherein the schema having versions each defining a data structure outlining a format and a data type of a message to be published by a data publisher onto a continuous integration/continuous delivery (CI/CD) pipeline and to be consumed by a data consumer from the CI/CD pipeline;
creating a file version of the schema;
generating corresponding metadata for each version of the schema that explains that version of the schema;
adding the metadata to the schema as a part of the schema for that file version of the schema;
registering the schema onto the centralized schema registry;
publishing, by the data publisher, the message corresponding to the registered schema onto the CI/CD pipeline; and
querying by the metadata, by the data consumer, the centralized schema registry to consume the message from the CI/CD pipeline.

16. The non-transitory computer readable medium of claim 15, wherein both the data publisher and the data consumer are located within same geographic regions with respect to data centers' location.

17. The non-transitory computer readable medium of claim 15, wherein both the data publisher and the data consumer are located in different geographic regions with respect to data centers' location.

18. The non-transitory computer readable medium of claim 15, wherein in creating the file version of the schema, the instructions, when executed, cause the processor to further perform the following:
creating a Java archive file version of the schema.

19. The non-transitory computer readable medium of claim 18, wherein the metadata points to the schema and maps the schema to the Java archive file version based on builds, wherein each build corresponds to a result of a process, implemented by the CI/CD pipeline, which is a version of an application that is ready for testing or deployment.

20. The non-transitory computer readable medium of claim 18, wherein the instructions, when executed, cause the processor to further perform the following:
executing a serialization process or a deserialization process using the registered schema from the centralized schema registry using the metadata; and
validating data stream, for distributed applications running on a public cloud, using the registered schema from the centralized schema registry by using the metadata.
